(19) United States
(12) Patent Application Publication
(10) Pub. No.: US 2015/0013329 A1
(43) Pub. Date: Jan. 15, 2015

(54) INLET DEVICE FOR AN AFTERCOOLER

(71) Applicant: Caterpillar Inc., Peoria, IL (US)

(72) Inventors: Dale L. Pennycuff, Lafayette, IN (US); Jeffrey A. Howard, West Lafayette, IN (US); Brian Boksa, Lafayette, IN (US)

(21) Appl. No.: 13/939,572

(22) Filed: Jul. 11, 2013

(51) Int. Cl. F02B 29/04

(52) U.S. Cl. CPC F02B 29/045
USPC 60/599; 138/39; 137/1

(57) ABSTRACT

An inlet device for an aftercooler is provided. The inlet device includes a body defining an elongated flowpath therein. The body includes a front opening disposed at a beginning of the flowpath. The body further includes a bottom opening disposed at an angle with respect to the front opening and at an end of the flowpath. The inlet device further includes at least two baffles disposed in the flowpath between the front opening and the bottom opening. The baffles have different heights measured from the bottom opening, and the respective heights of the baffles increase with distance from the front opening.

### TECHNICAL FIELD

The present disclosure relates to an aftercooler, and more particularly to an inlet device for the aftercooler.

### BACKGROUND

Turbochargers are employed in engine systems to deliver compressed air to an engine. However, during compression, the air tends to become hot and may affect a combustion process within the engine. In order to cool down the hot air before it is delivered into the engine, aftercoolers are positioned between the turbocharger and the engine. These aftercoolers may typically include heat exchanging components such as fins, tubes, or coils over which the hot air passes. In some cases, cooling of the hot air by the aftercooler may be uneven due to an uneven distribution of the hot air over the heat exchanging components of the aftercooler. The uneven cooling of the hot air may lead to reduced performance of the engine.

U.S. Pat. No. 4,452,216 (hereinafter “the '216 patent) discloses a means for evenly distributing the air flow through a core of an intercooler, and across a total cooling surface of the core. The '216 patent may be applicable to turbochargers or superchargers where an outlet port of the turbocharger or supercharger is substantially aligned to one or more inlet ports of the intercooler.

### SUMMARY OF THE DISCLOSURE

In one aspect, the present disclosure provides an inlet device for an aftercooler. The inlet device includes a body defining an elongated flowpath therein. The body includes a front opening disposed at a beginning of the flowpath. The body further includes a bottom opening disposed at an angle with respect to the front opening and at an end of the flowpath. The inlet device further includes at least two baffles disposed in the flowpath between the front opening and the bottom opening. The baffles have different heights measured from the bottom opening, wherein the respective heights of the baffles increase with distance from the front opening.

In another aspect, the present disclosure provides an engine system including a turbocharger, an aftercooler, and an inlet device. The turbocharger is configured to output compressed air. The aftercooler is configured to receive and cool the compressed air. The inlet device is disposed between the turbocharger and the aftercooler. The inlet device includes a body defining an elongated flowpath therein. The body includes a front opening disposed at a beginning of the flowpath. The front opening of the body is configured to receive the compressed air from the turbocharger. The body further includes a bottom opening disposed at an angle with respect to the front opening and at an end of the flowpath, the bottom opening configured to allow egress of the compressed air to the aftercooler. The inlet device further includes at least two baffles disposed in the flowpath between the front opening and the bottom opening. The baffles have different heights measured from the bottom opening, wherein the respective heights of the baffles increase with distance from the front opening.

In another aspect, the present disclosure provides a method of distributing air onto an aftercooler from an inlet device. The method includes receiving an incoming stream of air in a flowpath of the inlet device. The method further includes segregating the stream of air using at least two baffles disposed in the flowpath between a front opening and a bottom opening of the inlet device, the at least two baffles having different heights measured from the bottom opening, and wherein the respective heights of the at least two baffles increase with distance from the front opening. The method further includes deflecting the segregated air downwardly into the aftercooler.

Other features and aspects of this disclosure will be apparent from the following description and the accompanying drawings.

### BRIEF DESCRIPTION OF THE DRAWINGS

FIG. 1 is a perspective view of an an engine system, in accordance with an exemplary embodiment of the present disclosure;

FIG. 2 is a perspective view of an exemplary inlet device of the engine system;

FIG. 3 is a cross-sectional view of the exemplary inlet device of FIG. 2; and

FIG. 4 is a method of uniformly distributing air onto an aftercooler in accordance with an exemplary embodiment of the present disclosure.

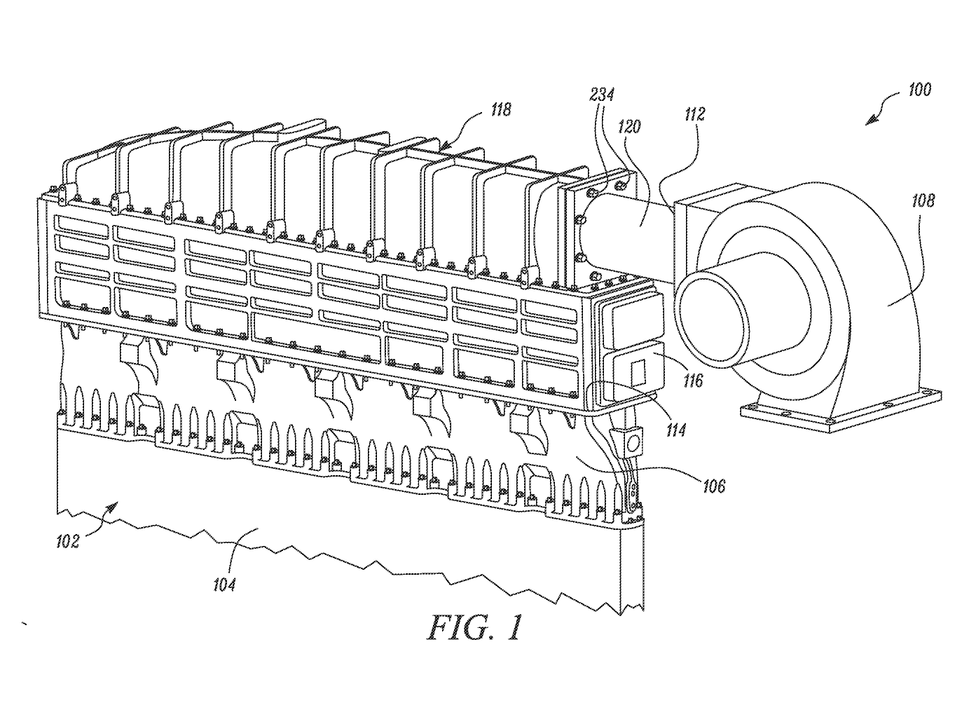

### DETAILED DESCRIPTION

Wherever possible, the same reference numbers will be used throughout the drawings to refer to the same or the like parts. FIG. 1 illustrates an exemplary engine system 100, according to one embodiment of the present disclosure. The engine system 100 may be employed in earth moving machines such as an off-highway truck, an earth-moving machine, such as a wheel loader, an excavator, a dump truck, a backhoe loader, a motor grader, a material handler, marine equipment, or the like. In an alternative embodiment, the engine system 100 may be employed in large stationary equipment like power-generators to drive the generator and generate electricity. In other embodiments, the engine system 100 may be employed to accomplish compression of gases.

The engine system 100 includes an engine 102. The engine 102 may be of any type such as, but not limited to, an inline engine, a V-engine, or a rotary engine. In an embodiment, the engine 102 may be a gas compression engine. In the exemplary embodiment shown in FIG. 1, the engine 102 may be an inline engine having an engine block 104, and an engine head 106. The engine 102 may include two or more cylinders (not shown) sequentially arranged in a row-wise manner within the engine block 104. The engine 102 may further include an air intake manifold (not shown) defined within the engine head 106. The air intake manifold may fluidly communicate with the cylinders and deliver air into the cylinders during combustion of fuel.

The engine system 100 further includes a turbocharger 108 configured to output compressed air to the engine 102. The turbocharger 108 may be driven by kinetic and thermal energy from hot exhaust gases of the engine 102 to compress filtered air from the atmosphere. Although the present disclosure is explained with reference to the turbocharger 108, the engine system 100 may employ a supercharger in place of the turbocharger 108. Structures, methods and various embodiments disclosed herein may be similarly applicable in the case of the engine system 100 employing the supercharger.

As shown in FIG. 1, the turbocharger 108 is located away from the engine 102. An outlet port 112 of the turbocharger 108 may be disposed in a substantially perpendicular relation to a top face 114 of the engine head 106. However, in other embodiments, the turbocharger 108 may be located at any distance from the engine 102 and the outlet port 112 of the turbocharger 108 may be disposed in any angular relation to the top face 114 of the engine head 106.

The engine system 100 further includes an aftercooler 116. The aftercooler 116 is positioned between the turbocharger 108 and the engine 102. The aftercooler 116 is releasably fastened to the top face 114 of the engine head 106. In alternative embodiments, the aftercooler 116 may be coupled at other locations on the engine 102. The aftercooler 116 may include heat exchanging components (not shown) commonly known in the art such as, but not limited to, fins, tubes, or coils therein. The aftercooler 116 is configured to receive the compressed air from the turbocharger 108, and cool the compressed air before delivering the cooled and compressed air into the engine 102.

The engine system 100 further includes an inlet device 118 disposed between the turbocharger 108 and the aftercooler 116. The inlet device 118 is fluidically connected to the turbocharger 108 via a conduit pipe 120. The inlet device 118 is configured to direct a flow of the compressed air from the turbocharger 108 into the aftercooler 116.

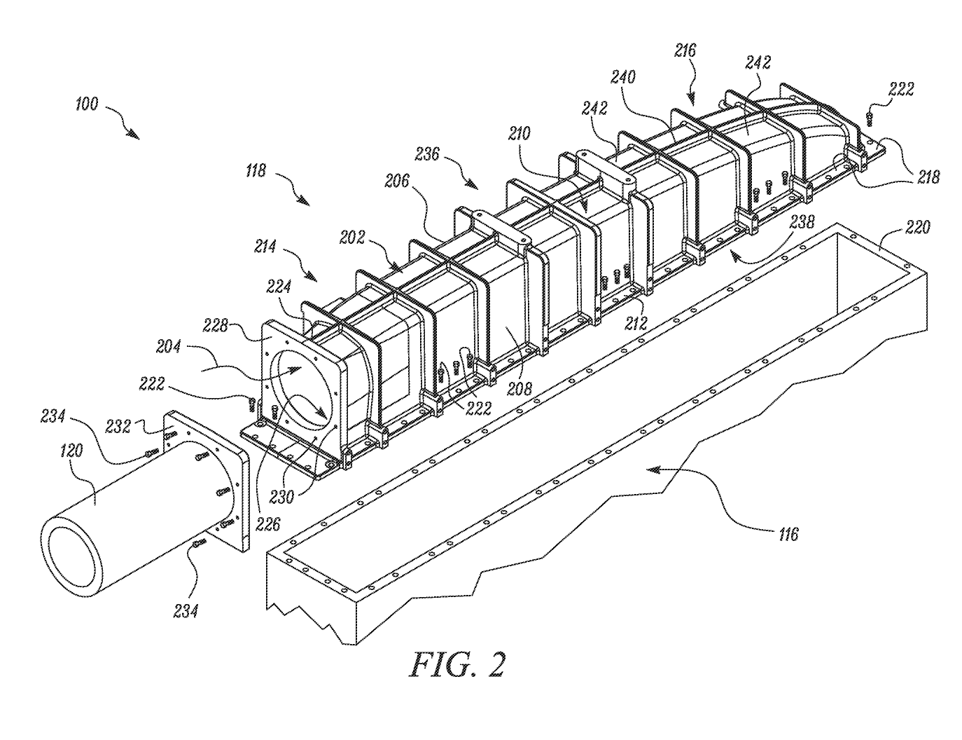

Referring to FIG. 2, the inlet device 118 includes a body 202 defining an elongated flowpath 204 therein. The body 202 includes a pair of sidewalls 206, 208 spaced apart from each other. The body 202 further includes a top wall 210 disposed on the pair of sidewalls 206, 208 to define the flowpath 204 therebetween. The inlet device 118 includes a pair of flanges 212 laterally extending from the pair of sidewalls 206, 208. The flanges 212 may extend into each other at a forward portion 214 and a rearward portion 216 of the body 202 to form a contiguous flange 218. The flanges 212 are configured to releasably couple with an inlet flange 220 of the aftercooler 116 by commonly known fasteners 222 such as hex bolts. However, in other embodiments, the inlet device 118 may be releasably coupled to the aftercooler 116 by using other structures known in the art such as, but not limited to, clamps, catch plates, or a tooth and socket mechanism. Further, gaskets (not shown) may be disposed between the flanges 212 of the inlet device 118 and the inlet flange 220 of the aftercooler 116.

The body 202 includes a front opening 224 disposed at a beginning of the flowpath 204 and configured to receive the compressed air from the turbocharger 108. The inlet device 118 further includes a plate 228 defining the front opening 224 and multiple smaller recesses 230 therethrough. The plate 228 may be coupled to a connection flange 232 on the conduit pipe 120. Commonly known fasteners 234 such as hex bolts or other types of fasteners may be used to fasten the plate 228 to the connection flange 232. Further, gaskets (not shown) may be disposed between the plate 228 and the connection flange 232.

The body further includes a bottom opening 226 disposed at an angle with respect to the front opening 224 and at an end of the flowpath 204. The bottom opening 226 is configured to allow egress of the compressed air to the aftercooler 116.

Although it may be evident from the present disclosure that the pair of sidewalls 206, 208 and the top wall 210 together form the unitary body 202, in an alternate embodiment, the body 202 may be comprised of two portions 236, 238 divided along a parting line 240. The two portions 236, 238 may together form the body 202 when positioned adjacent to each other along the parting line 240. In another embodiment, the portion 236 may be a first half-portion, while the portion 238 may be a second half-portion parted along the parting line 240 as shown in FIG. 2. The first and the second half-portions disclosed herein may include, for example, one of the sidewalls 206, 208, and a half-portion 242 of the top wall 210. Further, the first and second half-portions may be conjugate to each other. However, the body 202 may be divided into any number of portions to include any number of parting lines such that the portions may be joined along their mutually respective parting lines to form the body 202 of the inlet device 118.

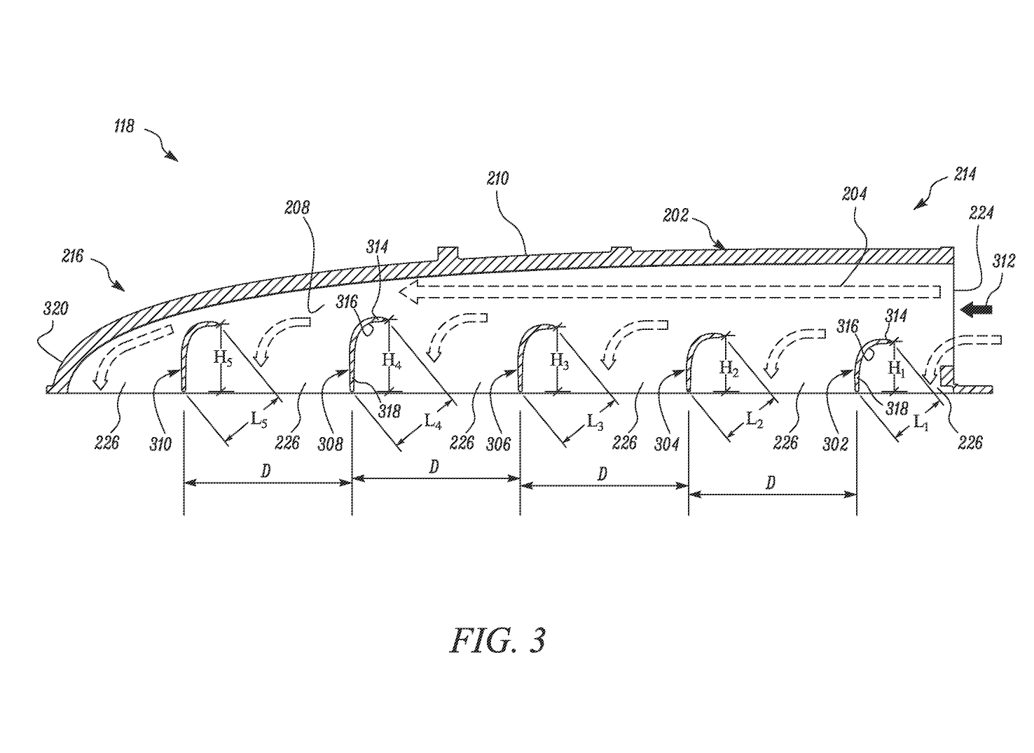

Referring to FIG. 3, a cross-sectional view of the inlet device 118 is shown. The inlet device 118 includes at least two baffles 302, 304, 306, 308, and 310 disposed in the flowpath 204 between the front opening 224 and the bottom opening 226. The baffles 302, 304, 306, 308, and 310 are configured to segregate an incoming stream of air entering the body 202 in direction 312. The baffles 302, 304, 306, 308, and 310 may extend between the pair of sidewalls 206, 208 of the body 202. As shown in FIG. 3, five baffles 302, 304, 306, 308, and 310 are disposed in the flowpath 204. Although five baffles 302, 304, 306, 308, and 310 are disclosed herein, it is envisioned that in other embodiments of the present disclosure, any number of baffles may be used depending on various factors such as, but not limited to, a volume of the incoming stream of air to be segregated, number of segregations to be accomplished on the incoming stream of air, and a pattern of air-distribution required onto the heat exchanging components of the aftercooler 116. Therefore, the five baffles 302, 304, 306, 308, and 310 disclosed herein are merely exemplary in nature, and hence, non-limiting to the present disclosure.

The baffles 302, 304, 306, 308, and 310 have different heights H₁, H₂, H₃, H₄, and H₅ measured from the bottom opening 226, wherein the respective heights of the baffles 302, 304, 306, 308, and 310 increases with distance from the front opening 224. As shown in FIG. 3, the baffles 302, 304, 306, 308, and 310 are sequentially arranged along the flowpath 204 from the front opening 224 to the bottom opening 226 in an ascending order of the height H₁, H₂, H₃, H₄, and H₅ of the baffles 302, 304, 306, 308, and 310. The height H₁ of baffle 302, as measured from the bottom opening 226 in a direction away from the bottom opening 226, is lesser than the height H₂ of baffle 304. Similarly, the height H₂ of baffle 304 is lesser than the height H₃ of baffle 306 and so on. The sequential arrangement of baffles 302, 304, 306, 308, and 310 in the ascending order of the height H₁, H₂, H₃, H₄, and H₅ may configure the baffles 302, 304, 306, 308, and 310 to segregate the incoming stream of air. The baffles 302, 304, 306, 308, and 310 are spaced apart from each other by a pre-determined distance D respectively. In one embodiment, the pre-determined distances D between adjacent baffles 302, 304, 306, 308, and 310 may be substantially equal. In another embodiment, the pre-determined distances D between adjacent baffles 302, 304, 306, 308, and 310 may be un-equal. The spacing of the baffles 302, 304, 306, 308, and 310 at the pre-determined distances D and the sequential arrangement of the baffles 302, 304, 306, 308, and 310 in the ascending order of the height H₁, H₂, H₃, H₄, and H₅ of the baffles 302, 304, 306, 308, and 310 may together configure the baffles 302, 304, 306, 308, and 310 to segregate the incoming stream of air substantially evenly across the bottom opening 226 for distribution over the heat exchanging components of the aftercooler 116.

In one embodiment, the baffles 302, 304, 306, 308, and 310 may be substantially air-foil shaped to include a pre-determined chord length L₁, L₂, L₃, L₄, and L₅. The chord length L₁, L₂, L₃, L₄, and L₅ disclosed herein, may be determined based on various factors such as, but not limited to, a volume of the incoming stream of air to be segregated, and a volume of air required in each segregation to accomplish a specific pattern of air-distribution onto the heat exchanging components of the aftercooler 116. Each of the baffles 302, 304, 306, 308, and 310 may include a tip portion 314, an arcuate portion 316, and a linear portion 318.

The tip portion 314 is configured to segregate the incoming stream of air. In an exemplary embodiment, the tip portion 314 may have a pointed end configuration. However, in alternative embodiments, the tip portion 314 may have a rounded end configuration. The arcuate portion 316 extends from the tip portion 314 and is configured to collect the segregated air. The linear portion 318 extends from the arcuate portion 316 and is configured to guide the collected air from the turbocharger 108 into the aftercooler 116.

Although a profile of the baffles 302, 304, 306, 308, and 310 is disclosed herein to include the tip portion 314, the arcuate portion 316, and the linear portion 318, any suitable profile may be used and any number of portions may be included in the profile of the baffles 302, 304, 306, 308, and 310 depending on specific requirements of an application. Hence, a person having ordinary skill in the art may acknowledge that the structure of the baffles 302, 304, 306, 308, and 310 in terms of tip portion 314, the arcuate portion 316, and the linear portion 318 are merely exemplary in nature and non-limiting of this disclosure.

Referring to FIG. 3, the top wall 210 may extend in an arcuate shape away from the front opening 224 such that a distal end 320 of the top wall defines at least a portion of the bottom opening 226. The distal end 320 of the curvilinear top wall 210 is configured to deflect the segregated stream of air downwardly into the bottom opening 226. In this way, the curvilinear top wall 210 may smoothly deflect the compressed air from the turbocharger 108 into the aftercooler 116.

In other embodiments, the top wall 210 may be uniplanar in cross-section and thus define a flat top shape for the body 202. However, the shapes of the top wall 210 disclosed herein are merely exemplary in nature and hence, non-limiting of this disclosure. It is to be noted that the shape of the top wall 210 may be selected based on various factors such as, but not limited to, space constraints, deflection requirements of air, and distribution of air over the aftercooler 116.

In an alternative embodiment, the pair of sidewalls 206, 208 may be inwardly curved towards the rearward portion 216 of the body 202. The inwardly curved sidewalls 206, 208 and the curvilinear top wall 210 may together impart a cowl shape to the rearward portion 216 of the body 202. Although, the arcuate shape and the cowl shape of the rearward portion 216 is disclosed herein, it is to be noted that the elongated body 202 may be embodied in other shapes commonly known in the art such as but not limited to, a box-shape for example, thereby resulting in a flattened shape of the rearward portion 216. However, it is to be noted that the shape of the rearward portion 216 may change depending on requirements of a specific application. Therefore, a person having ordinary skill in the art may acknowledge that the shapes of the rearward portion 216 disclosed herein are merely exemplary and hence, non-limiting to this disclosure.

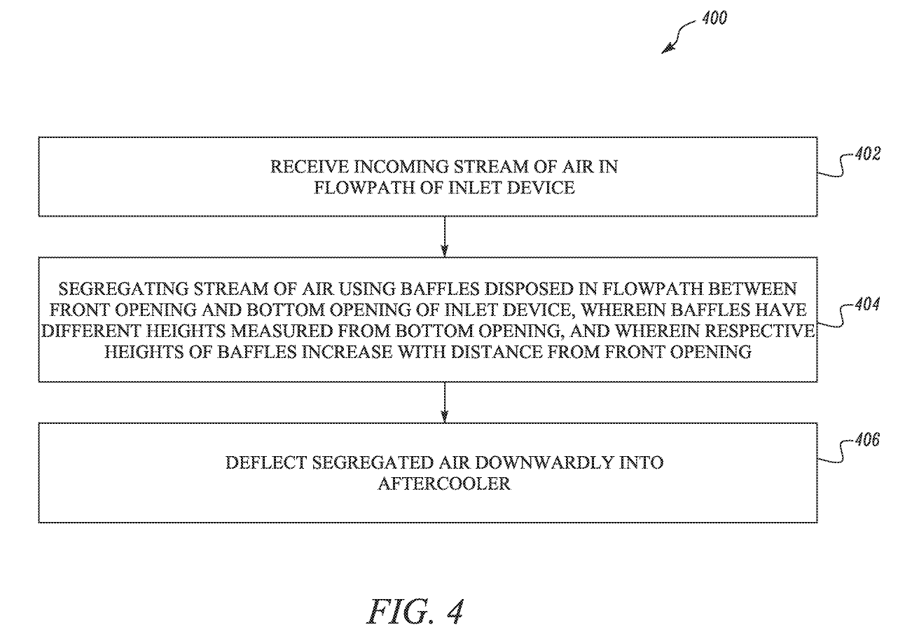

A method 400 of distributing air onto the aftercooler 116 from the inlet device 118 will be described in connection with FIG. 4.

### Industrial Applicability

Many aftercoolers are known in the art to cool down a stream of hot compressed air from a turbocharger before being delivered into the engine. These aftercoolers are typically positioned between the turbocharger and the engine. The aftercoolers may include heat exchanging components such as fins, tubes, or coils over which the hot air is passed in order to cool down. While these aftercoolers perform cooling of the hot air, the cooling may be uneven due to an uneven distribution of the hot air over the heat exchanging components of the aftercooler. This uneven cooling of the hot air may result in a creation of hot-spots within the aftercooler or the engine and in some cases, reduce a performance of the aftercooler or the engine.

The present disclosure provides the inlet device 118 for the aftercooler 116. More specifically, the disclosure provides the inlet device 118 configured to segregate and distribute the incoming stream of air over the aftercooler 116. The baffles 302, 304, 306, 308, and 310 of the inlet device 118 are arranged in a manner such that the baffles 302, 304, 306, 308, and 310 are configured to evenly segregate the incoming stream of air before distributing it onto the aftercooler 116. The arrangement of the baffles 302, 304, 306, 308, and 310 in their ascending order of height H₁, H₂, H₃, H₄, and H₅ and the pre-determined distance D between the baffles 302, 304, 306, 308, and 310 configures the baffles 302, 304, 306, 308, and 310 to accomplish even segregation of the incoming air. Further, the profile of the baffles 302, 304, 306, 308, and 310 allow deflection of the evenly segregated air over the heat exchanging components of the aftercooler 116. Therefore, the baffles 302, 304, 306, 308, and 310 of the inlet device 118 are arranged in a manner such that the baffles 302, 304, 306, 308, and 310 are configured to evenly segregate and distribute the incoming stream of air onto the aftercooler 116.

The design of the inlet device 118 disclosed herein provides a uniform distribution of the incoming stream of air onto the heat exchanging components of the aftercooler 116 such that the segregated air may be uniformly cooled in the aftercooler 116 before being delivered into the air intake manifold and the cylinders of the engine 102. Further, the uniform air distribution by the inlet device 118 may result in a reduction of hot-spots in the conduit pipe 120, the inlet device 118, the aftercooler 116, the intake manifold, and the cylinders of the engine 102 where combustion occurs. Therefore, the engine 102 and the aftercooler 116 may have enhanced performance and reliability against failures.

At step 402, the stream of air is received in the flowpath 204 of the inlet device 118. The incoming stream of air represents hot compressed air from the turbocharger 108. Typically, air compressed within the turbocharger 108 or the supercharger becomes hot due to the compression occurring therein. In an exemplary embodiment, increase in the temperature of air due to the compression in the turbocharger 108 may be governed by the ideal gas law equation as follows:

P.V=n.R.T eq. 1;

wherein P=pressure of air;

V=volume of air;

T=temperature of air;

R=ideal or universal gas constant i.e. 8.314 J.K⁻¹.mol⁻¹; and

n=amount of substance in air.

At step 404, the baffles 302, 304, 306, 308, and 310 disposed in the flowpath 204 between the front opening 224 and the bottom opening 226 of the inlet device 118 segregate the stream of air 312. The baffles have different heights H₁, H₂, H₃, H₄, and H₅ measured from the bottom opening 226, wherein the respective heights H₁, H₂, H₃, H₄, and H₅ of the baffles 302, 304, 306, 308, and 310 increase with distance from the front opening 224. The baffles 302, 304, 306, 308, and 310, disclosed herein, are sequentially arranged in the ascending order of the height H₁, H₂, H₃, H₄, and H₅ of the baffles 302, 304, 306, 308, and 310, from the front opening 224 of the body 202. Referring to FIG. 3, a cross-sectional area of the flowpath 204 decreases with distance from the front opening 224. Therefore, the incoming stream of air 312 may be offered progressively narrower passages between the baffles 302, 304, 306, 308, and 310 and the top wall 210 of the body 202 to pass through. While successive baffles 302, 304, 306, 308, and 310 segregate the incoming stream of air, the increasingly narrower passages serve to maintain or increase a velocity of the incoming stream of air remnant after segregations at the baffles 302, 304, 306, 308, and 310. The incoming stream of air remnant after segregation by the baffle 302 may move with an increased velocity towards the baffle 304 and air remnant after segregation by the baffle 304 may move with an increased velocity towards the baffle 306. Thus, the increasingly narrowing passages defined between the baffles 302, 304, 306, 308, and 310 and the top wall 210 presents decreasing cross-sectional area of the flowpath 204 to the stream of incoming air thus affecting the velocity of the stream of incoming air.

In an embodiment, segregating the stream of air by the baffles 302, 304, 306, 308, and 310 further comprises segregating the stream of air substantially evenly across the bottom opening 226, and substantially evenly across an area of the aftercooler 116. The baffles 302, 304, 306, 308, and 310 may be spaced apart from each other by the pre-determined distance D such that the baffles 302, 304, 306, 308, and 310 are configured to segregate the stream of air 312 substantially evenly over an area of the aftercooler 116.

At step 406, the segregated air is deflected downwardly into the aftercooler 116. The baffles 302, 304, 306, 308, and 310 may be formed with profiles that serve to guide the incoming stream of air downwardly into the aftercooler 116. Upon even segregation of the incoming stream of air, the segregated air is deflected downwardly into the aftercooler 116. The even segregation and distribution of the stream of incoming air onto the heat exchanging components of the aftercooler 116 allows uniformity in cooling of the stream of incoming air as the segregated air passes around the heat exchanging components. As a result, a possibility of creation of hot-spots within the aftercooler 116 or the engine 102 may be minimized.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An inlet device for an aftercooler, the inlet device comprising:
a body defining an elongated flowpath therein, the body comprising:
a front opening disposed at a beginning of the flowpath; and
a bottom opening disposed at an angle with respect to the front opening and at an end of the flowpath; and
at least two baffles disposed in the flowpath between the front opening and the bottom opening, wherein the at least two baffles have different heights measured from the bottom opening, and wherein the respective heights of the at least two baffles increase with distance from the front opening.

2. The inlet device of claim 1, wherein the at least two baffles are spaced apart from each other by a pre-determined distance such that the baffles are configured to segregate the incoming stream of air substantially evenly across the bottom opening.

3. The inlet device of claim 1, wherein the baffles are substantially air-foil shaped, wherein each of the baffles include a pre-determined chord length.

4. The inlet device of claim 1, wherein each of the baffles comprises:
a tip portion configured to segregate the incoming stream of air;
an arcuate portion extending from the tip portion and configured to collect the segregated air; and
a linear portion extending from the arcuate portion, the linear portion configured to guide the collected air into the aftercooler.

5. The inlet device of claim 1, wherein the body comprises:
a pair of sidewalls spaced apart from each other; and
a top wall disposed on the pair of sidewalls to define the flowpath therebetween.

6. The inlet device of claim 5, wherein the at least two baffles extend between the pair of sidewalls.

7. The inlet device of claim 5 further comprising a pair of flanges laterally extending from the pair of sidewalls, the flanges configured to releasably couple with an inlet flange of the aftercooler.

8. The inlet device of claim 5, wherein the top wall extends in an arcuate shape away from the front opening such that a distal end of the top wall defines at least a portion of the bottom opening, and wherein the distal end of the top wall is configured to deflect the segregated stream of air downwardly into the bottom opening.

9. The inlet device of claim 8, wherein a cross-sectional area of the flowpath decreases with distance from the front opening.

10. An engine system comprising:
a turbocharger configured to output compressed air;
an aftercooler configured to receive and cool the compressed air; and
an inlet device disposed between the turbocharger and the aftercooler, the inlet device comprising:
a body defining an elongated flowpath therein, the body comprising:
a front opening disposed at a beginning of the flowpath and configured to receive the compressed air from the turbocharger; and
a bottom opening disposed at an angle with respect to the front opening and at an end of the flowpath, the bottom opening configured to allow egress of the compressed air to the aftercooler; and
at least two baffles disposed in the flowpath between the front opening and the bottom opening, wherein the at least two baffles have different heights measured from the bottom opening, and wherein the respective heights of the at least two baffles increase with distance from the front opening.

11. The engine system of claim 10 further comprising an engine comprising an engine head, wherein an outlet port of the turbocharger is disposed in a substantially perpendicular relation to a top face of the engine head.

12. The engine system of claim 10, wherein the at least two baffles are spaced apart from each other by a pre-determined distance such that the baffles are configured to segregate the incoming stream of air substantially evenly across the bottom opening.

13. The engine system of claim 10, wherein each of the baffles comprises:
a tip portion configured to segregate the incoming stream of air;
an arcuate portion extending from the tip portion and configured to collect the segregated air; and
a linear portion extending from the arcuate portion, the linear portion configured to guide the collected air into the aftercooler.

14. The engine system of claim 10, wherein the body comprises:
a pair of sidewalls spaced apart from each other; and
a top wall disposed on the pair of sidewalls to define the flowpath therebetween.

15. The engine system of claim 14, wherein the at least two baffles extend between the pair of sidewalls.

16. The engine system of claim 14 further comprising a pair of flanges laterally extending from the pair of sidewalls, the flanges configured to releasably couple with an inlet flange of the aftercooler.

17. The engine system of claim 14, wherein the top wall extends in an arcuate shape away from the front opening such that a distal end of the top wall defines at least a portion of the bottom opening, and wherein the distal end of the top wall is configured to deflect the segregated stream of air downwardly into the bottom opening.

18. The engine system of claim 18, wherein a cross-sectional area of the flowpath decreases with distance from the front opening.

19. A method of distributing an incoming stream of air onto an aftercooler from an inlet device, the method comprising:
receiving the incoming stream of air in a flowpath of the inlet device;
segregating the stream of air using at least two baffles disposed in the flowpath between a front opening and a bottom opening of the inlet device, wherein the at least two baffles have different heights measured from the bottom opening, and wherein the respective heights of the at least two baffles increase with distance from the front opening; and
deflecting the segregated air downwardly into the aftercooler.

20. The method of claim 19, wherein segregating the stream of air by the baffles further comprises segregating the stream of air substantially evenly across the bottom opening, and substantially evenly across an area of the aftercooler.
